(19) United States
(12) Patent Application Publication
(10) Pub. No.: US 2007/0091141 A1
(43) Pub. Date: Apr. 26, 2007

(54) Ink-jet image forming apparatus to maintain a nozzle unit

(75) Inventors: Youn-gun Jung, Gunpo-si (KR); Jin-ho Park, Yongin-si (KR); Dong-woo Ha, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics., Ltd., Suwon-si (KR)

(21) Appl. No.: 11/488,041

(22) Filed: Jul. 18, 2006

(30) Foreign Application Priority Data
Oct. 20, 2005 (KR) 10-2005-0099335

(51) Int. Cl. B41J 2/165

(52) U.S. Cl. 347/33

(57) ABSTRACT

An ink-jet image forming apparatus includes an ink-jet head having a nozzle unit having a length in a main scanning direction corresponding to a width of a printing medium, a platen to face the nozzle unit, to support a rear side of the printing medium, and to form a paper conveying path, and a wiping unit to clean the nozzle unit. The platen has a printing location in which the paper conveying path is formed, a maintenance location different from the printing location, and a replacement location in which the wiping unit is replaced.

### CROSS-REFERENCE TO RELATED APPLICATIONS

This application claims priority under U.S.C. §119(a) from Korean Patent Application No. 10-2005-0099335, filed on Oct. 20, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, and more particularly, to an ink-jet image forming apparatus having an ink-jet head, a nozzle unit having the length in a main scanning direction corresponding to a width of a printing medium, and a wiping unit to clean the nozzle unit.

2. Description of the Related Art

In general, ink-jet image forming apparatuses are apparatuses for ejecting ink on a paper transferred to a subscanning direction from an ink-jet head (shuttle type ink-jet head) which is driven to reciprocate in a main scanning direction and forming an image. The ink-jet head is equipped with a nozzle unit in which a plurality of nozzles ejecting ink is disposed. Non-ejected ink droplets remain around the nozzle unit. While a printing operation is not performed, if the nozzle unit is exposed to the air, ink droplets around the nozzle unit may be solidified, and foreign substances such as fine dust may be attached to the nozzle unit from the air. Due to the solidified ink or foreign substances, an ink ejecting direction may be distorted and printing quality may be lowered. In addition, ink in the nozzle unit is evaporated and the nozzle unit is clogged. To prevent such a phenomenon, the ink-jet image forming apparatus performs a maintenance operation including a wiping operation for removing foreign substances of the nozzle unit.

Recently, an attempt has been made to implement high-speed printing by using the ink-jet head (the array ink-jet head) equipped with the nozzle unit having a length in the main scanning direction corresponding to a Width of the paper, instead of the shuttle type ink-jet head, is performed. In the ink-jet image forming apparatus, the ink-jet head is fixed, and only the paper is transferred to a subscanning direction perpendicular to the main scanning direction. Therefore, a drive unit of the ink-jet image forming apparatus is simple and implementation of the high-speed printing is possible. In the ink-jet image forming apparatus, if a printing margin of a width direction of the paper is not considered, the length of the nozzle unit is about 210 mm to correspond to the paper of A4, for example. Unlike the shuttle type ink-jet head which is driven in a main scanning direction with reciprocation, since the array ink-jet head ejects ink in a fixed location, when a portion of a plurality of nozzles is clogged or an ink ejecting direction is distorted by foreign substances, it is difficult to complement the problem, that is, difficult to clean the array ink-jet head. Thus, a wiping operation needs to be effectively performed. In addition, a wiping unit needs to be replaced with a new one after a life span thereof.

### SUMMARY OF THE INVENTION

The present general inventive concept provides an ink-jet image forming apparatus in which a nozzle unit of an array ink-jet head is effectively wiped.

The present general inventive concept also provides an ink-jet image forming apparatus in which a wiping unit is simply replaced with another one.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an ink-jet image forming apparatus, including an ink-jet head having a nozzle unit having a length in a main scanning direction corresponding to a width of a printing medium, a platen to face the nozzle unit, to support a rear side of the printing medium, and to form a paper conveying path with the nozzle unit, and a wiping unit to clean the nozzle unit, wherein the platen has a printing location in which the paper conveying path is formed, a maintenance location moved from the printing location, and a replacement location in which the wiping unit is replaced.

The ink-jet image forming apparatus may further include a wiping locus to guide the wiping unit to clean the nozzle unit when the platen is moved to the printing location and the maintenance location, respectively, wherein the wiping unit is combined with a combining portion of the platen, and a deviation groove and an opening are disposed in the wiping locus and the combining portion, respectively, so as to replace the wiping unit when the platen is located in the replacement location

When the platen is moved to the printing location from the maintenance location, the wiping locus may guide the wiping unit to clean the nozzle unit, and when the platen is moved to the maintenance location from the printing location, the wiping unit is moved not to contact the nozzle unit according to a guidance of the wiping locus.

When the platen is moved to the printing location from the maintenance location, a front-end thereof may push the wiping unit, and when the platen is moved to the maintenance location from the printing location, the combining portion may pull the wiping unit.

The wiping unit may include: a support member having a first protrusion guided by the wiping locus and a second protrusion combined with the combining portion; and a wiper installed at the support member and cleaning the nozzle unit.

The combining portion may pull the second protrusion after the platen begins to move to the maintenance location from the printing location and a predetermined delay time is elapsed, and a first scrapper contacting and cleaning the wiper for the delay time may be disposed in the platen.

The wiping locus may include a stopper disposed therein so that the first protrusion can be located for the delay time and the wiping unit cannot be moved.

The wiping unit may include a second scrapper disposed therein to contact and clean the first scrapper for the delay time.

The foregoing and/or other aspects of the present general inventive concept may also be achieved by providing an ink-jet image forming apparatus, including an ink-jet head having a nozzle unit having a length in a main scanning direction corresponding to a width of a printing medium, a platen to face the nozzle unit, to support a rear side of the printing medium, and to form a paper conveying path with the nozzle unit, and a wiping unit to clean the nozzle unit, wherein the platen is moved to a printing location in which the paper conveying path is formed and to a maintenance location moved from the printing location, the wiping unit is installed in the platen and cleans the nozzle unit when the platen is moved to the printing location from the maintenance location, and the platen includes a first scrapper disposed therein to cross and clean the wiping unit when the platen is moved to the maintenance location from the printing location.

The foregoing and/or other aspects of the present general inventive concept may also be achieved by providing an ink-jet image forming apparatus including an ink-jet head including a nozzle unit to form an image having the same length as a width of a printing medium in a main scanning direction of the printing medium without moving in the main scanning direction, a maintenance device to maintain the nozzle unit, and a platen disposed in a printing location to face the nozzle unit to form a paper conveying path with the inkjet head, to move to a maintenance location different from the printing location to control the maintenance device to maintain the nozzle unit, and to move a replacement location different from the printing location and/or the maintenance location to control the maintenance to be separated from the plate.

The foregoing and/or other aspects of the present general inventive concept may also be achieved by providing an ink-jet image forming apparatus including an ink-jet head including a nozzle unit to form an image having the same length as a width of a printing medium in a main scanning direction of the printing medium without moving in the main scanning direction, a platen disposed to move between a printing location and a maintenance location, a maintenance device detachably attached to the platen to maintain the nozzle unit according to a movement of the platen, and a unit to move the maintenance device to a position in which the maintenance device is detachable from the platen in a replacement location.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an ink-jet image forming apparatus according to an embodiment of the present general inventive concept;

FIG. 2 is a view illustrating a nozzle unit of the ink-jet image forming apparatus of FIG. 1;

FIG. 3 is a view illustrating a maintenance unit of the ink-jet image forming apparatus according to an embodiment of the present inventive concept;

FIG. 4 is an exploded perspective view illustrating a platen and a wiping unit of the maintenance unit of FIG. 3;

FIG. 5 is a cross-sectional view illustrating the platen of FIG. 4;

FIG. 6 is a cross-sectional view illustrating the wiping unit of FIG. 4;

FIG. 7 is a plane view illustrating a combining state of the platen and the wiping unit of FIG. 4;

FIG. 8 is an exploded perspective view illustrating the maintenance unit FIG. 3;

FIG. 9 is a view illustrating a guide slot and a wiping locus of the maintenance unit of FIG. 8;

FIG. 10 is a perspective view illustrating the wiping locus of the maintenance unit of FIG. 8;

FIG. 11 is a view illustrating a structure to drive a cap member using a driving motor in the maintenance unit of FIGS. 3 and 8;

FIG. 12 is a perspective view illustrating a swing gear and a driven gear connected to the driving motor of FIG. 11;

FIG. 13A is a view illustrating a state in which locations of the wiping unit and the platen are indicated in the wiping locus and the guide slot, respectively, in a printing location of maintenance unit of FIG. 8;

FIGS. 13B and 14 are views illustrating a scrapping operation using first and second scrappers, respectively, in the maintenance unit of FIG. 8;

FIG. 15 is a view illustrating a state in which the platen and the wiping unit are moved to a maintenance location after the scrapping operation in the maintenance unit of FIG. 8;

FIG. 16 is a view illustrating a capping operation of the maintenance unit of FIG. 8;

FIG. 17 is a view illustrating an uncapping operation of the maintenance unit of FIG. 8;

FIG. 18 is a view illustrating a state in which the platen and the wiping unit are moved to the printing location and a wiping operation is performed in the maintenance unit of FIG. 8;

FIG. 19 is a view illustrating a state in which locations of the platen and the wiping unit are indicated in the wiping locus and the guide slot, respectively, in a replacement location of the maintenance unit of FIG. 8; and

FIG. 20 is a view illustrating a state in which the wiping unit is replaced in the maintenance unit of FIG. 8.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

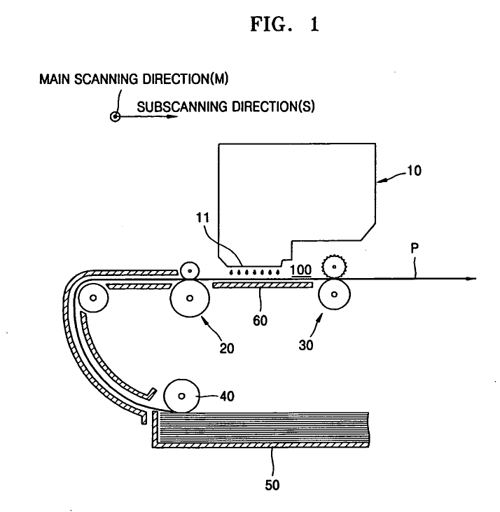

FIG. 1 is a view illustrating an ink-jet image forming apparatus according to an embodiment of the present general inventive concept. Referring to FIG. 1, a printing medium, such as a sheet of paper P picked up by a pickup roller 40 from a paper feeding cassette 50 is conveyed by a conveying unit 20 in a sub-scanning direction S, i.e., a paper feeding direction of the paper P. An ink-jet head 10 is installed in an upward direction of the paper P. The ink-jet head 10 prints an image on the paper P by ejecting ink on the paper P in a fixed location using a nozzle unit 11. The paper P is discharged by an exhaust (discharging) unit 30 after the image is formed on the paper P.

The ink-jet head 10 is an array ink-jet head mounted with the nozzle unit 11 having a length in a main scanning direction M corresponding to a width of the paper P. Here, since the length of the nozzle unit 11 is referred to as the width of the paper P, the ink-jet head 10 can form the image on the paper P without reciprocating in a widthwise direction of the paper P, that is, the nozzle unit 11 is arranged in the widthwise direction to cover the width of the paper P. Thus, when the paper P is delivered to the nozzle unit 11 in the sub-scanning direction perpendicular to the widthwise direction, the nozzle unit 11 can print the image having the width of the paper P on the paper P without moving in the widthwise direction of the paper P.

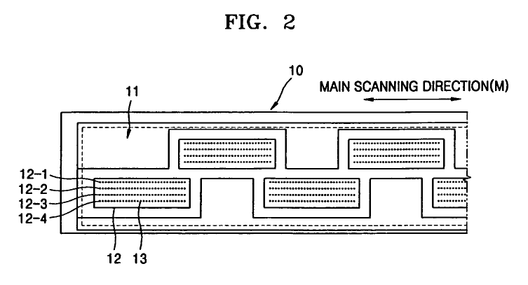

FIG. 2 is a view illustrating the nozzle unit 11 of the ink-jet image forming apparatus of FIG. 1. Referring to FIG. 2, the nozzle unit 11 includes a plurality of nozzle plates 12 arranged in a zig-zag pattern in the main scanning direction M. A plurality of nozzles 13 to eject the ink is formed in each nozzle plate 12. A plurality of nozzle rows 12-1,12-2,12-3, and 12-4 can be arranged in the nozzle plate 12. And each nozzle row 12-1, 12-2,12-3 or 12-4 can eject the ink of the same color or different color, for example, cyan, magenta, yellow, and black. Although FIG. 2 illustrates an example of the nozzle unit 11, the scope of the present general inventive concept is not limited thereto. Although not shown, the ink-jet head 10 includes a chamber which communicates with each nozzle 13, and ejecting units (for example, a piezo element and a heater) disposed in the chamber to provide pressure for ejecting the ink, and a channel to supply the ink to the chamber. The chamber, the ejecting units, and the channel are well-known and thus, a detailed description thereof will be omitted.

The platen 60 is disposed to face the nozzle unit 11, supports a rear side of the paper P, and forms a paper conveying path 100 with the nozzle unit 11. The platen 60 is disposed so that the nozzle unit 11 of the ink-jet head 10 can maintain a predetermined interval between the nozzle unit 11 and the paper P, for example, an interval of 0.5-2 mm. The exhaust unit 30 is installed at an outlet of the ink-jet head 10 to discharge the paper P.

While a printing operation is not performed, if the nozzle unit 11 is exposed to the air, ink droplets around the nozzle unit 11 may be solidified, and foreign substances such as fine dust may be attached to the nozzle unit 11 from the air. Due to the solidified ink or foreign substances, an ink ejecting direction may be distorted and printing quality may be lowered. In addition, ink in the nozzle unit 11 is continuously evaporated and the nozzle unit 11 is clogged. Since the ink-jet head 10 is disposed in a fixed position to print the image, if a portion of the nozzles 13 is clogged, a white line appears on the printed image.

In order to implement good print quality, the nozzle unit 11 has to be optimally maintained in a state for printing. To this end, a maintenance operation including spitting, wiping, and capping is performed. When a printing operation has not been performed for a predetermined amount of time or a number of the nozzles 13 have not been used for a predetermined amount of time during the printing operation, the nozzles 13 and the ink around the nozzles 13 are dried so that viscosity of the ink is increased and an ejecting defect occurs. Spitting is ejecting the ink several times for a predetermined amount of time so as to remove the ink of which viscosity is increased. Wiping is removing the solidified ink or the solidified ink and foreign substances around the nozzles 13 by scrubbing a surface of the nozzle unit 11. Capping is covering and blocking the nozzle unit 11 from an external air, thereby preventing the nozzles 13 from being dried when the printing operation is not performed for a predetermined amount of time.

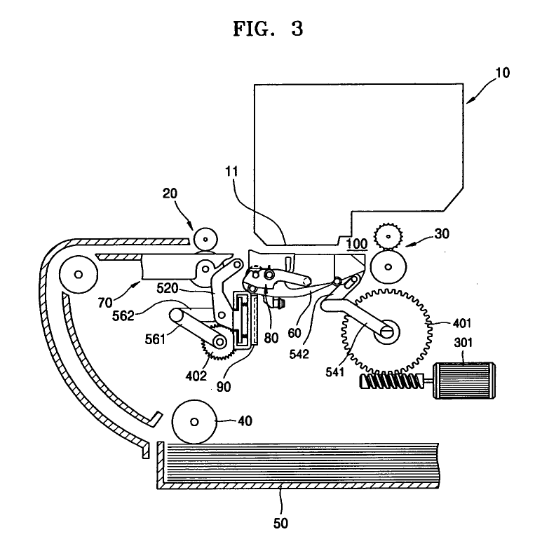

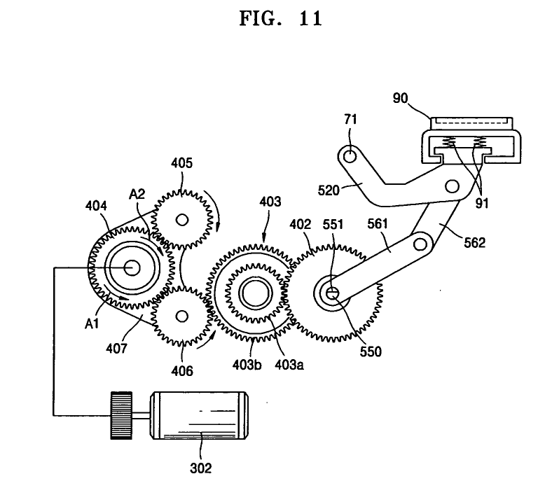

Referring to FIG. 3, the ink-jet image forming apparatus includes a cap member 90 to cap the nozzle unit 11, and a wiping unit 80 to wipe the nozzle unit 11. The ink-jet image forming apparatus is moved to a printing location (see a solid line of FIG. 3) in which the platen 60 forms the paper conveying path 100 and a maintenance location to which the platen 60 is moved from a lower part of the nozzle unit 11 to avoid an interference with a maintenance device, such as the wiping unit 80 and/or the cap member 90, so that the wiping unit 80 and/or the cap member 90 can access to the nozzle unit 11. A unit including the conveying unit 20 and the exhaust unit 30 is not moved during the maintenance operation. The wiping unit 80 is installed at the platen 60 and moved with the platen 60 to clean the nozzle unit 11. The wiping unit 80 is moved according to a force generated from a first driving motor 301 and transmitted through a first driven gear 401, a first connecting arm 541, and a second connecting arm 542. The cap member 90 is moved by a force generated from a second driving motor 302 (FIG. 11) and transmitted through a second driven gear 402, a third connecting arm 561, a fourth connecting arm 562, and a cap arm 520.

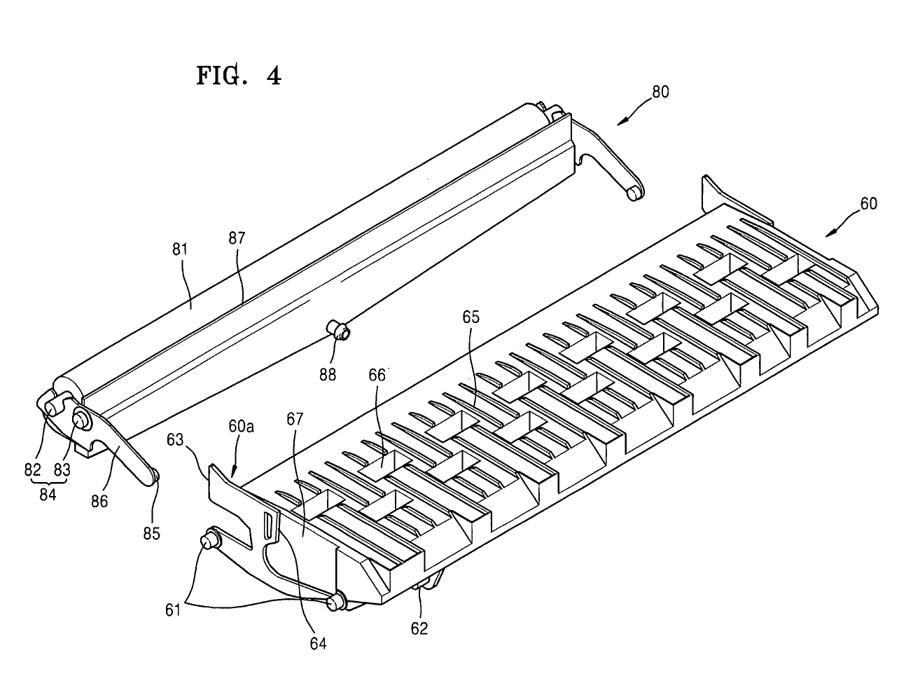

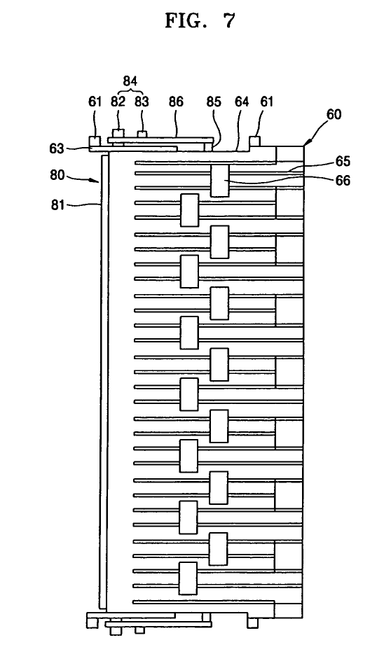

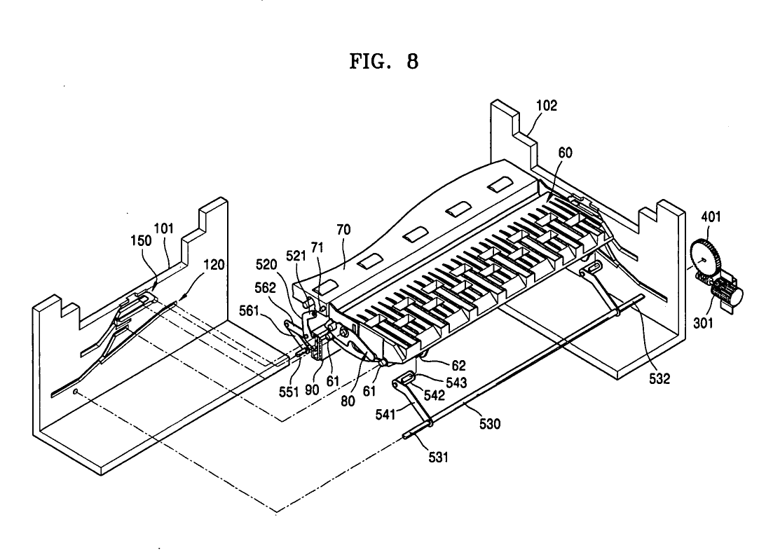

Referring to FIGS. 4 through 7, the platen 60 includes a plurality of ribs 65 disposed therein to support the rear side of the paper P. In addition, in order to accommodate the spitted ink, the platen 60 includes a plurality of accommodating portions 66 disposed therein to correspond to the arrangement of the plurality of nozzle plates 12 of FIG. 2. An interference portion (plate) 60a is disposed on a side (or both sides) of the platen 60 and is formed with a front-end portion (a first inference portion) 63 and a combining portion (a second interference portion) 64. The combining portion (second interference portion) 64 is disposed beside (adjacent to a side of) the platen 60. The wiping unit 80 includes a support member 86, a wiper 81, and a second scrapper 87. The wiper 81 is a roller-shaped wiper that is rotated in contact with the nozzle unit 11. A shaft 82 of the wiper 81 is combined with the support member 86. The support member 86 includes a first protrusion 84 inserted in a wiping locus 150 (FIG. 8) which will be described later, and a second protrusion 85 combined with the second interference portion (the combining portion) 64. The shaft 82 serves as the first protrusion 84 with a protrusion 83. The front-end portion (first interference portion) 63 of the platen 60 pushes the wiping unit 80 in the same direction as a direction in which the platen 60 is moved to the printing location from the maintenance location. The first inference portion 63 pushes the shaft 82 of the wiper 81. The second interference portion 64 pulls the second protrusion 85 of the wiping unit 80 in the same direction as a direction in which the platen 60 is moved to the maintenance location from the printing location. Protrusions 61 (FIG. 7) are connected to a guide slot 120 (FIG. 8), and a drain 88 is formed on the wiping unit 80 to guide the wiped ink to an outside of the maintenance device. A guide pole 62 is formed on the platen 60 to be connected to the second connecting arm 542 (FIG. 8). An opening 67 is formed on between the combining portion 64 and the protrusion 61 on the interference portion (plate) 60a to provide a space through which the second protrusion 85 of the wiping unit 80 is separated from the combining portion 64 and guided to an outside of the apparatus, so that the wiping unit 80 is replaced with a new one, as illustrated in FIG. 4.

Referring to FIGS. 8-10, the platen 60 is combined with side walls 101 and 102. The guide slot 120 is disposed in the side walls 101 and 102. The protrusion 61 is disposed on both sides of the platen 60. The protrusion 61 is inserted in the guide slot 120. The platen 60 is moved to the printing location and the maintenance location along the guide slot 120. The guide slot 120 includes a parallel section 121 parallel to the paper conveying path 100 and an inclined section 122 inclined in a downward direction. A slot 543 is formed in the form of a long hole in the second connection arm 542. The guide pole 62 disposed in the platen 60 is inserted into the slot 543. A shaft 530 is supported to be rotated in the side walls 101 and 102. D-cut parts 531 and 532 are disposed on both ends of the shaft 530. That is, the shaft 530 has a circular cross section and a cut-off portion formed thereon to form the D-cut parts 531 so that the shaft 530 is fixedly coupled to the first connecting arm 541 having the corresponding cutoff portion of the shaft 530. A pair of first connection arms 541 is combined with the d-cut parts 531 and 532 of the shaft 530 and connected to a pair of second connection arms 542 to be pivoted. The first driven gear 401 is combined with the d-cut part 532. The maintenance motor 301 rotates the first driven gear 401 to move the platen 60 to the printing location and the maintenance location, respectively.

A wiping locus 150 is disposed on the side walls 101 and 102. The first protrusion 84 of the wiping unit 80 is combined with the wiping locus 150. The wiping locus 150 includes a first section 151 in which the wiping unit 80 is guided to contact the nozzle unit 11 and a sustain section 152 in which the wiping unit 80 is maintained in contact with the nozzle unit 11 as the platen 60 is moved to the printing location from the maintenance location. The first section 151 may have an extended section 151a to dispose the wiping unit 80 in a non-wiping position after completing the wiping operation according to a movement of the platen 60 from the printing location to the maintenance location. When the platen moves from the maintenance location to the printing location, the wiping unit moves from the non-wiping position to a rest position corresponding to the printing location of the platen 60.

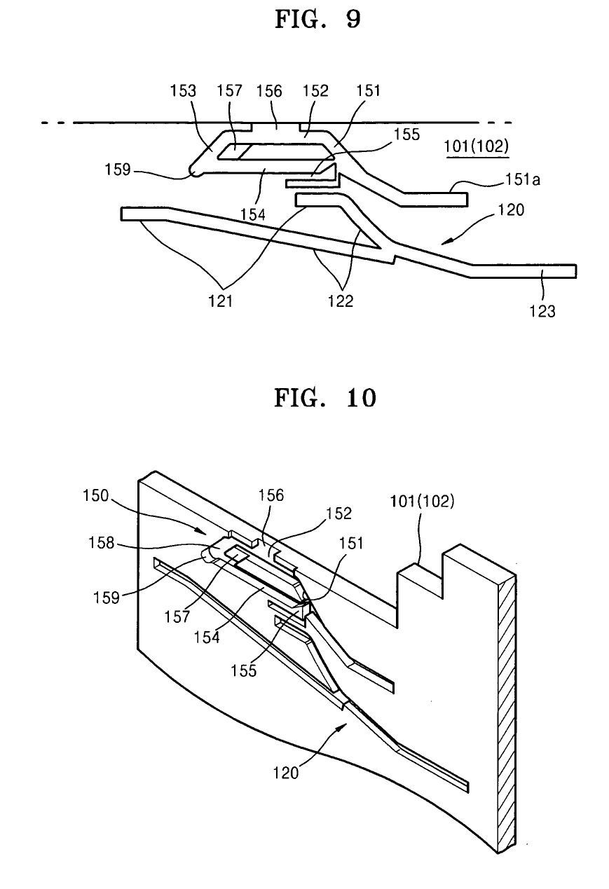

The wiping locus 150 further includes a third section 153 in which the wiping unit 80 is separated from the nozzle unit 11. The wiping locus 150 further includes a fourth section 154 in which the wiping unit 80 is guided not to contact the nozzle unit 11 when the platen 60 is moved to the maintenance location from the printing location. The protrusion 83 and the shaft 82 that serves as the first protrusion 84 are guided by the second section 152 to support the wiper 81 stably while the wiper 81 cleans (wipes) the nozzle unit 11. As illustrated in FIGS. 9 and 10, a step part 157 stepped from a bottom surface of the third section 153 is disposed in the third section 153 so that the wiper 81 is rapidly separated from the nozzle unit 11 in the third section 153. The shaft 82 is longer than the protrusion 83. If the first protrusion 84 is pushed by the first inference portion 63 of the platen 60 and reaches an end of the second section 152, the protrusion 83 reaches the step part 157. Then, the first protrusion 84 rapidly passes through the third section 153 by weight of the wiping unit 80 and enters the fourth section 154. That is, the protrusion 83 moves downward along the step part 157 while the shaft 82 moves along the end of the second section 152. A concave stopper 159 is disposed in a starting part of the fourth section 154. The shaft 82 that has passed through the third section 153 is inserted in the stopper 159. An elastic arm 155 serves as a latch which allows the protrusion 84 to be moved to the first section 151 from the fourth section 154 and blocks the protrusion 84 from moving to the fourth section 154 from the first section 151.

The elastic arm 155 is disposed in a first position to provide a narrow gap between the fourth and first sections 154 and 151 to prevent the protrusion 84 from moving back to the fourth section 154 from the first section 151, and in a second position to provide a wide gap between the fourth and first sections 154 and 151 to allow the protrusion 84 to easily move from the fourth section 154 to the first section 151. The wiping locus 150 further includes an extended section 151a extended from the first section 155 to dispose the wiping unit 80 in a retract position corresponding to the maintenance location of the platen 60.

In the ink-jet image forming apparatus, the platen 60 has a replacement location besides the printing location and the maintenance location so as to easily replace the wiping unit 80 with another one (or a new one) during or after a life span of the wiping unit 80. The wiping unit 80 can be replaced, for example, when a defect is found even during the life span thereof. In order to replace the wiping unit 80, the first protrusion 84 should be deviated (separated or removed) from the wiping locus 150. In addition, the second protrusion 85 should be deviated (removed or separated) from the second inference portion 64. To this end, a deviation groove 156 is disposed in the wiping locus 150, as illustrated in FIGS. 9 and 10. In addition, the opening 67 is disposed in the second inference portion 64 and is defined by a surface of the interference portion (plate) on which the first and second interference portions 63 and 64 are formed, as illustrated in FIG. 4. When the platen 60 is located in the replacement location, the first protrusion 84 is located in the deviation groove 156. The replacement location is disposed in the middle of the printing location and the maintenance location, and the deviation groove 156 is disposed in the second section 152.

The replacement location may be disposed between the printing location and the maintenance location. That is, the wiping unit 80 can move between a rest position corresponding to the printing location of the platen 60 and a non-wiping position corresponding to the maintenance location of the platen 60. The wiping unit can move to a replacement position between the non-wiping position and the rest position according to a movement of the platen 60 to a middle portion from the maintenance location to the printing location. The guide slot 120 further includes an extended section 123 extended from the inclined section 122 to dispose the platen 60 in the maintenance location. When the platen 60 moves from the maintenance location corresponding to the non-wiping position of the wiping unit 80 along the inclined section 122 through the extended section 123 and is disposed in a middle position along the inclined section 122, the wiping unit 80 is disposed in the replacement position.

The first, second, third, and fourth sections 151, 152, 153, and 154 constitute a cam groove to be combined with the protrusion 84 to move the wiping unit 80. The cam groove is formed in the side wall 101 in a first direction in which the protrusion 84 is disposed in the cam groove and a second direction in which the protrusion 84 moves along the cam groove, and the deviation groove 156 is formed in second section 152 of the side wall 101 in a third direction and is defined as an opening of the cam groove so that the protrusion 84 is separated from the cam groove to an outside of the side wall 101 and/or the apparatus. That is, the third direction is perpendicular to the first and second directions, so that the wiping unit 80 can be removable from the side wall 101 without moving a portion of the side wall 101. Since the replacement location of the platen 60 is different from the printing location and/or the maintenance location, a space is provided between the platen 60 and the ink-jet head 10 so that the wiping unit 80 can be taken out therefrom.

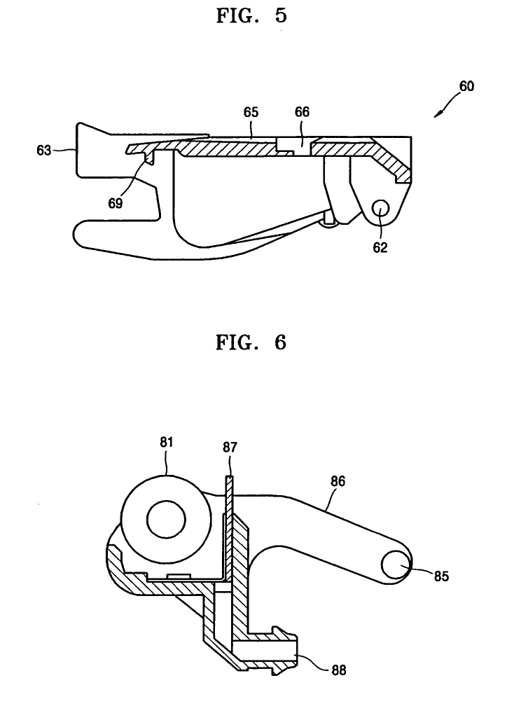

In order to implement a stable wiping function, the wiper 81 needs to be cleaned. In addition, an operation of cleaning the wiper 81 may be performed before the nozzle unit 11 is wiped. Thus, the operation of cleaning the wiper 81 is performed while the platen 60 is moved to the maintenance location from the printing location. As illustrated in FIG. 5, the first scrapper 69 to clean the wiper 81 is disposed in the platen 60. When the platen 60 is moved to the maintenance location from the printing location so that the first scrapper 69 can clean foreign substances of the wiper 81 using the operation of moving the platen 60, at least the wiper 81 needs to be stopped temporarily. The second inference portion 64 begins to be moved to the maintenance location from the printing location and pulls the second protrusion 85 after a predetermined delay time is elapsed. Then, for the delay time, the wiping unit 80 is not moved and only the platen 60 is moved so that the first scrapper 69 can clean the wiper 81. For example, if a distance between the second inference portion 64 and the first inference portion 63 is smaller than a distance between a portion (the shaft 82 of the wiper 81) of the wiping unit 80 pulled by the first inference portion 63 and the second protrusion 85, there is a difference between a time when the platen 60 begins to be moved and a time when the wiper 81 begins to be moved.

To implement a more stable wiping function, the wiping unit 80 may further include a second scrapper 87 to clean the first scrapper 69. The second scrapper 87 is located parallel to the wiper 81, and the first scrapper 69 to clean the wiper 81 contacts the second scrapper 87 for the delay time. Foreign substances removed from the first scrapper 69 using the second scrapper 87 are received in the wiping unit 80 or discharged to the drain 88.

Referring to FIGS. 3 and 8, the cap arm 520 is installed in the guide member 70 guiding the paper P in a downward direction of the nozzle unit 11, to be pivoted. One end 521 of the cap arm 520 is combined with a pivot shaft 71 disposed in the guide member 70. The cap member 90 is installed on the other end 522 of the cap arm 520. A shaft 550 (FIG. 11) is supported to be rotated on the side walls 102 and 102. Ad-cut part 551 is disposed on both ends of the shaft 530. A pair of third connection arms 561 is combined with the d-cut part 551 of the shaft 550 and connected to a pair of fourth connection arms 562 to be pivoted. The pair of fourth connection arms 562 is connected to the cap arm 520 to be pivoted.

A driving source for moving the platen 60 and the wiping unit 80 and a driving source for moving the cap member 90 may be the same or independent. As the length in a sub-scanning direction S of the nozzle unit 11 increases, a moving distance of the platen 60 increases. In this case, two driving sources may be independent. The platen 60 and the wiping unit 80 are driven using the maintenance motor 301, and the cap member 90 is driven using the driving motor 302 to drive the conveying unit 20 and the exhaust unit 30. In this case, the pickup roller 40 for picking up the paper P from the paper feeding cassette 50 may be driven using another driving source. When the pickup roller 40 is driven using the driving motor 302, a clutch unit (not shown) to selectively transfer a driving force of the second driving motor 302 to the pickup roller 40 may be disposed. The clutching unit is well-known and thus, a detailed description thereof will be omitted.

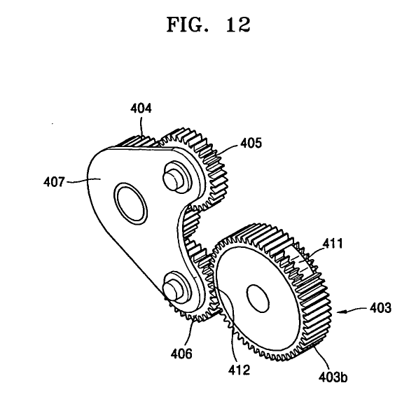

FIGS. 11 and 12 are views illustrating a mechanism to drive the cap member 90 to a capping location and an uncapping location using the driving motor 302 driving the conveying unit 20 and the exhaust unit 30, respectively, in the maintenance unit of FIGS. 3 and 8. Although not shown, the second driving motor 302 is connected to the conveying unit 20 and the exhaust unit 30 using a power connection element such as a gear. While performing a capping operation, since the paper P is not picked up from the paper feeding cassette 50 even when the second driving motor 302 is driven to operate the conveying unit 20 and the exhaust unit 30, the paper P is not conveyed. The second driven gear 402 is combined with the d-cut part 551 of the shaft 550. A third driven gear 403 includes first and second gear parts 403a and 403b. The first gear part 403a is engaged with the second driven gear 402. A pair of swing gears 405 and 406 is engaged with a gear 404 rotated with the second driving motor 302. The pair of swing gears 405 and 406 is installed at a swing arm 407. The pair of swing gears 405 and 406 selectively comes in contact with the second gear part 403b of the third driven gear 403 according to a rotational direction of the gear 404.

A pair of idling parts 411 and 412 of which tooth form is omitted is disposed in the second gear part 403b of the driven gear 403. The pair of idling parts 411 and 412 corresponds to the uncapping location and the capping location, respectively. The pair of idling parts 411 and 412 correspond to the pair of swing gears 405 and 406, respectively. If the gear 404 is rotated in a direction A1, the swing arm 407 is rotated in the direction A1 and the swing gear 406 comes in contact with the second gear part 403b of the third driven gear 403. The cap member 90 is moved to the capping location from the uncapping location. If the cap member 90 reaches the capping location, the swing gear 406 is disposed in the idling part 412, and even though the swing gear 406 is rotated, the cap member 90 is not rotated. If the gear 404 is rotated in a direction A2, the swing arm 407 is also rotated in the direction A2 and the swing gear 405 is engaged with the second gear part 403b of the third driven gear 403. The cap member 90 is moved to the uncapping location from the capping location. If the cap member 90 reaches the uncapping location, the swing gear 405 is disposed in the idling part 411, and even though the swing gear 405 is rotated, the cap member 90 is not rotated. When the second driving motor 302 rotates the gear 404 in the direction A2, the conveying unit 20 and the exhaust unit 30 may operate in a direction in which the paper P is conveyed in the sub-scanning direction S. The conveying unit 20 and the exhaust unit 30 and the cap member 90 can be driven using the second driving motor 302 with the above structure.

A wiping operation and an operation of replacing the wiping unit 80 with the above structure will now be described. Referring to FIGS. 3, 4, 8,13A, and 13B, the platen 60 is located in the printing location and supports the rear side of the paper P. The protrusion 61 of the platen 60 is supported by the parallel section 121 of the guide slot 120 parallel to the paper conveying path 100. Thus, even though location precision in the printing location of the platen 60 is a little lowered, as long as the protrusion 61 is supported by the parallel section 121, an interval between the nozzle unit 11 and an upper side of the paper P can be precisely maintained. The wiping unit 80 and the cap member 90 are located under the platen 60. The first protrusion 84 of the wiping unit 80 is located in the fourth section 154. In this state, the conveying unit 20 is driven using the driving motor 302, the paper P is conveyed on the paper conveying path 100, ink is ejected onto the paper, and an image is printed. At this time, since the swing gear 405 is disposed in the idling part 411 of the driven gear 403, the driven gear 403 is not rotated. Thus, the cap member 90 is not moved in the uncapping location. In addition, the spitting operation is performed when the paper P does not exist on the paper conveying path 100 before an image is printed or after several sheets of paper are printed. The spitted ink is dropped in the accommodating portions 66 disposed in the platen 60 to correspond to the arrangement of the nozzle plates 12. Thus, even though the paper P is conveyed after spitting, the rear side of the paper P is not contaminated by the ink accommodated in the accommodating portions 66.

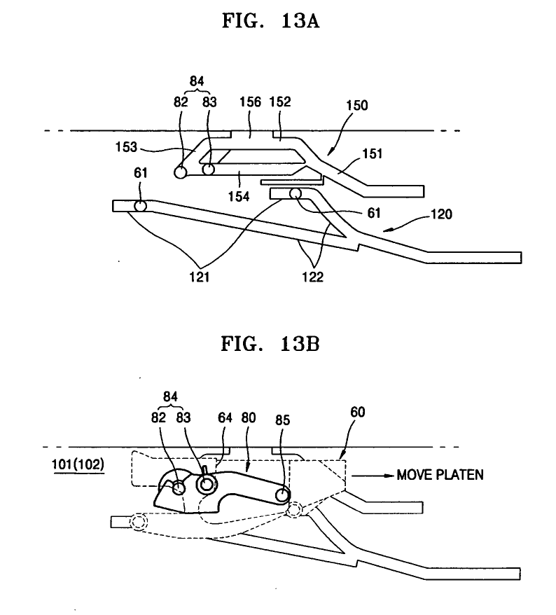

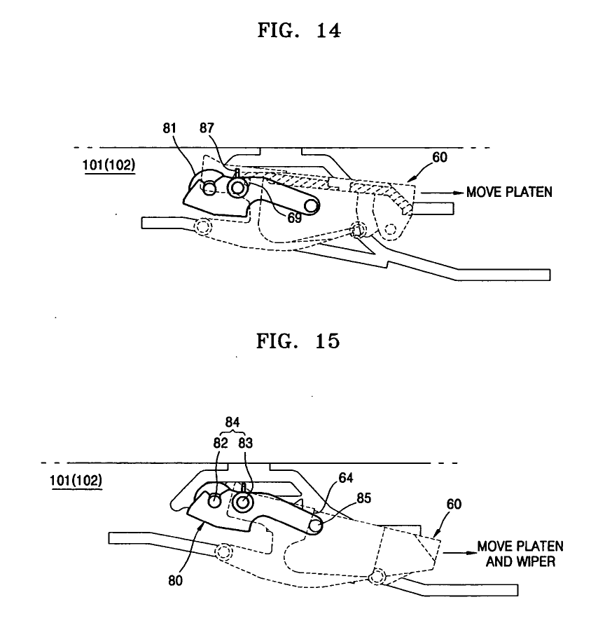

If the maintenance motor (or first driving motor) 301 rotates the first driven gear 401 for the maintenance operation, the shaft 530 and the first and second connection arms 541 and 542 connected thereto are rotated. The slot 543 of the second connection arm 542 pulls the guide pole 62. If the protrusion 61 of the platen 60 is deviated from the parallel section 121, it is guided by an inclined section 122. The platen 60 begins to be moved to the maintenance location. At this time, as shown in FIG. 13A, the first protrusion 84 of the wiping unit 80 is located in the fourth section 154 of the wiping locus 150. In addition, the second protrusion 85 is separated from the second inference portion 64 to be disposed in the opening 67 or move along a surface of the interference portion (plate) 60a (FIG. 4) to be removed through the opening 67. Thus, as illustrated in FIG. 13B, even though the platen 60 is moved, the wiping unit 80 is not moved and stopped. In particular, since the shaft 82 is located in the stopper 159, the wiping unit 80 is maintained in the fixed location while a scrapping operation is performed by the first scrapper 69 and the second scrapper 87. When the platen 60 is moved, as illustrated in FIG. 14, the first scrapper 69 contacts the wiper 81, and foreign substances are moved to the first scrapper 69 from the wiper 81. When the platen 60 is continuously moved to the maintenance location, the first scrapper 69 contacts the second scrapper 87, and foreign substances of the first scrapper 69 are transferred to the second scrapper 87. The foreign substances are received in the wiping unit 80 or discharged to the drain 88.

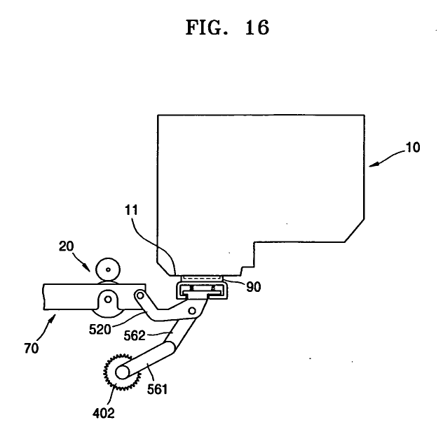

If the platen 60 is continuously moved and the second inference portion 64 contacts the second protrusion 85 as illustrated in FIG. 15, the wiping unit 80 is guided to the fourth section 154 of the wiping locus 150 and moved with the platen 60. If the platen 60 reaches the maintenance location, the first protrusion 84 pushes the elastic arm 155 and enters the first section 151.

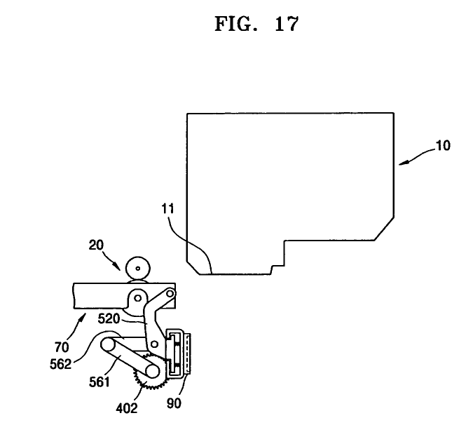

The driving motor 302 is driven to perform an operation of capping the nozzle unit 11. Even in this case, although the conveying unit 20 is driven, because the paper P is not picked up from the paper supply cassette 50, the paper P is not conveyed. Referring to FIGS. 11 and 12, if the second driving motor 302 rotates the gear 404 in direction A1, the swing gear 406 is engaged with the second gear part 403b of the third driven gear 403. The third driven gear 403 is rotated in the direction A1, and the first and second connection arms 541 and 542 push the cap arm 520. The cap arm 520 pivots around a pivot shaft 71 (FIG. 8) disposed in the guide member 70. As illustrated in FIG. 16, if the cap member 90 caps the nozzle unit 11, the swing gear 406 is located in the idling part 412 of the third driven gear 403. The cap member 90 is not moved although the driving motor 302 is rotated. If the driving motor 302 rotates the gear 404 in direction A2 for an uncapping operation, the swing gear 405 goes in gear with the second gear part 403b of the driven gear 403. The driven gear 403 is rotated in the direction A2, and the connection arms 541 and 542 pull the cap arm 520. The cap arm 520 pivots on the pivot axis 71 disposed in the guide member 70. And the cap member 90 is separated from the nozzle unit 11 and reaches the uncapping location, as illustrated in FIG. 17. The swing gear 405 is located in the idling part 411 of the driven gear 403. The cap member 90 is not moved although the driving motor 302 is rotated.

Next, the platen 60 is moved to the printing location. If the maintenance motor 301 rotates the first driven gear 401, the platen 60 begins to be moved to the printing location. In this case, as illustrated in FIG. 18, the first inference portion 63 pushes the shaft 82 of the wiper 81 and moves the wiping unit 80 in the same direction. Since the elastic arm 155 serves as a latch, the first protrusion 84 of the wiping unit 80 does not enter the fourth section 154 but enters the first section 151 and the wiper 81 contacts the nozzle unit 11. After the wiper 81 contacts the nozzle unit 11, the first protrusion 84 enters the second section 152. When the wiper 81 contacts the nozzle unit 11, the wiping unit 80 is moved with the platen 60. Foreign substances of the nozzle unit 11 are removed by the wiper 81. If the first protrusion 84 reaches an end of the second section 152, the first protrusion 84 rapidly passes through the third section 153 by weight of the wiping unit 80 and is located in a starting part of the fourth section 154. The platen 60 reaches the printing location. In this state, the printing operation is performed.

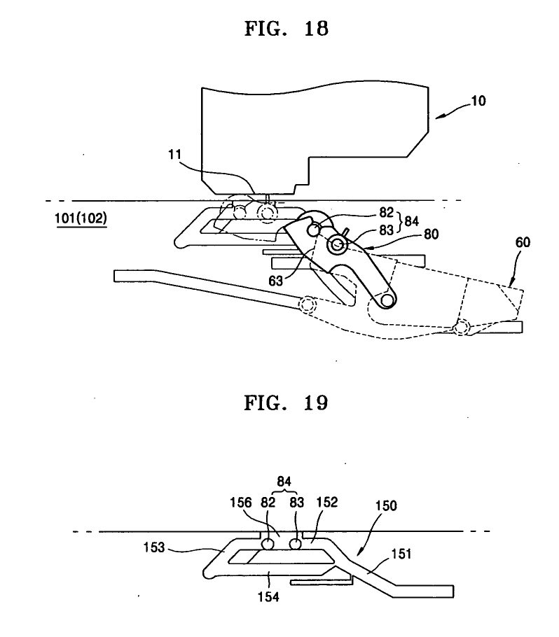

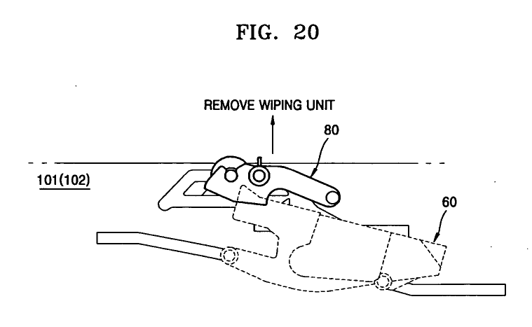

In order to replace the wiping unit 80, the platen 60 is stopped in the replacement location. Then, the first protrusion 84 is located in the deviation groove 156, as illustrated in FIG. 19. In this state, as illustrated in FIG. 20, the user separates the wiping unit 80 through the deviation groove 156 and the opening 67 of the second interference portion 64 after removing the ink-jet head 10 and can mount a new wiping unit 80.

As described above, in the ink-jet image forming apparatus according to the present embodiment, since the wiper can be easily replaced a predetermined period of time corresponding to a life span thereof, good printing quality can be continuously maintained. In addition, since the wiper is cleaned, a wiping function can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink-jet image forming apparatus comprising:
an ink-jet head including a nozzle unit having a length in a main scanning direction corresponding to a width of a printing medium;
a platen to face the nozzle unit, to support a rear side of the printing medium, and to form a paper conveying path with the ink-jet head; and
a wiping unit to clean the nozzle unit,
wherein the platen has a printing location in which the paper conveying path is formed with the ink-jet head, a maintenance location different from the printing location, so that a maintenance is performed using the wiping unit, and a replacement location in which the wiping unit is replaced.

2. The ink-jet image forming apparatus of claim 1, further comprising:
a wiping locus to guide the wiping unit to clean the nozzle unit when the platen is moved to at least one of the printing location and the maintenance location,
wherein the wiping unit is combined with a combining portion of the platen, the wiping locus comprises a deviation groove disposed therein, and the combining portion comprises an opening disposed therein, so as to replace the wiping unit when the platen is located in the replacement location

3. The ink-jet image forming apparatus of claim 2, wherein, when the platen is moved to the printing location from the maintenance location, the wiping locus guides the wiping unit to clean the nozzle unit, and when the platen is moved to the maintenance location from the printing location, the wiping locus controls the wiping unit not to contact the nozzle unit.

4. The ink-jet image forming apparatus of claim 3, wherein, when the platen is moved to the printing location from the maintenance location, a front-end thereof pushes the wiping unit, and when the platen is moved to the maintenance location from the printing location, the combining portion pulls the wiping unit.

5. The inkjet image forming apparatus of claim 4, wherein the wiping unit comprises:
a support member having a first protrusion guided by the wiping locus and a second protrusion combined with the combining portion; and
a wiper installed at the support member to clean the nozzle unit.

6. The ink-jet image forming apparatus of claim 5, wherein the combining portion pulls the second protrusion after the platen begins to be moved to the maintenance location from the printing location and a predetermined delay time is elapsed, and the platen comprises a first scrapper disposed therein to contact and clean the wiper for the delay time.

7. The ink-jet image forming apparatus of claim 6, wherein the wiping locus comprises a stopper disposed therein so that the first protrusion is located for the delay time and the wiping unit is not moved.

8. The ink-jet image forming apparatus of claim 6, wherein the wiping unit comprises a second scrapper disposed therein to contact and clean the first scrapper for the delay time.

9. The ink-jet image forming apparatus of claim 8, wherein a distance between the front-end of the platen and the combining portion is smaller than a distance between a portion of the wiping unit controlled by the front-end and the second protrusion.

10. An ink-jet image forming apparatus comprising:
an ink-jet head including a nozzle unit having a length in a main scanning direction corresponding to a width of a printing medium;
a platen to face the nozzle unit, to support a rear side of the printing medium, and to form a paper conveying path with the ink-jet head; and
a wiping unit to clean the nozzle unit,
wherein:
the platen is moved to a printing location in which the paper conveying path is formed and to a maintenance location different from the printing location,
the wiping unit is installed in the platen and cleans the nozzle unit when the platen is moved to the printing location from the maintenance location, and
the platen comprises a first scrapper disposed therein to cross and clean the wiping unit when the platen is moved to the maintenance location from the printing location.

11. The ink-jet image forming apparatus of claim 10, wherein the platen comprises:
a first inference portion to push the wiping unit when the platen is moved to the printing location from the maintenance location; and
a second inference portion to pull the wiping unit when the platen is moved to the maintenance location from the printing location,
wherein the second inference portion pulls the wiping unit after the platen begins to be moved to the maintenance location from the printing location and a predetermined delay time is elapsed so that the first scrapper and the wiping unit can cross each other.

12. The ink-jet image forming apparatus of claim 11, wherein:
the wiping unit comprises a support member having a first protrusion guided by the wiping locus, a second protrusion combined with the combining portion, and a wiper installed at the support member to clean the nozzle unit: and
the first scrapper contacts the wiper and removes foreign substances of the wiper for the delay time.

13. The ink-jet image forming apparatus of claim 12, wherein the wiping unit comprises a second scrapper disposed therein to contact and clean the first scrapper for the delay time.

14. The ink-jet image forming apparatus of claim 12, wherein the wiping locus comprises a stopper disposed therein so that the first protrusion is located for the delay time and the wiping unit does not move.

15. The ink-jet image forming apparatus of claim 14, wherein a distance between the first inference portion and the second inference portion is smaller than a distance between a portion of the wiping unit pulled by the first interference portion and the second protrusion.

16. The ink-jet image forming apparatus of claim 10, further comprising:
a wiping locus to guide the wiping unit to clean the nozzle unit when the platen is moved to the printing location from the maintenance location, and to control the wiping unit not to contact the nozzle unit when the platen is moved to the maintenance location from the printing location,
wherein:
the platen further has a replacement location in which the wiping unit is replaced;
the wiping unit comprises a deviation groove to control the first protrusion to be separated from the wiping locus when the platen is located in the replacement location; and
the second interference portion comprises an opening through which the second protrusion is separated from the second interference portion.

17. An ink-jet image forming apparatus comprising:
an ink-jet head including a nozzle unit of which a length in a main scanning direction corresponds to a width of a printing medium and to form an image without moving in the main scanning direction;
a maintenance device to maintain the nozzle unit; and
a platen disposed in a printing location to face the nozzle unit to form a paper conveying path with the ink-jet head, to move to a maintenance location different from the printing location to control the maintenance device to maintain the nozzle unit, and to move a replacement location different from the printing location and/or the maintenance location to control the maintenance to be separated from the platen.

18. The ink-jet image forming apparatus of claim 17, wherein the maintenance device is connected to the platen when the platen moves between the printing location and the maintenance location, and is disconnectable from the platen in the replacement location.

19. The ink-jet image forming apparatus of claim 17, wherein the maintenance device moves to a replacement position between a non-maintaining position and a rest position according to a movement of the platen to the replacement location between the printing location and the maintenance location.

20. The ink-jet image forming apparatus of claim 17, further comprising:
a guide slot to control the platen to move to the printing location, the maintenance location, and the replacement location; and
a cam groove to control the maintenance device to move to a rest position, a non-maintaining position, and a replacement position to correspond to the printing location, the maintenance location, and the replacement location, respectively, according to a movement of the platen along the guide slot.

21. The ink-jet image forming apparatus of claim 20, wherein the cam groove comprises a section formed in a direction to move the maintenance device between a rest position and a non-wiping position, and a deviate groove formed on a portion of the section in a second direction in which the wiping unit is taken out therefrom.

22. The ink-jet image forming apparatus of claim 21, wherein the section of the cam groove comprises a first section to guide the maintenance device to move from a non-maintaining position, a second section to guide the maintenance device from the non-maintaining position to a rest position, a third section to continuously guide the maintenance device to the rest position, and a fourth section to guide the maintenance device from the rest position to the non-maintaining position through a maintaining position in which the maintenance device maintains the nozzle unit.

23. The ink-jet image forming apparatus of claim 22, wherein the second section and the fourth section are disposed parallel to each other.

24. The ink-jet image forming apparatus of claim 22, wherein the first and third sections are disposed between the second and fourth sections to be widened from the second section toward the fourth section.

25. The ink-jet image forming apparatus of claim 22, wherein the maintenance device comprises a shaft and a protrusion spaced apart from the shaft, the shaft and the protrusion inserted into the cam groove, and the third section comprises a step part to move one of the shaft and protrusion to the fourth section faster than the other one of the shaft and protrusion such that a portion of the maintenance device corresponding to the one of the shaft and protrusion is separated from the nozzle unit faster than the other portion of the shaft and protrusion.

26. The ink-jet image forming apparatus of claim 22, wherein the deviate groove is formed on at least one of the first, second, third, and fourth sections.

27. The ink-jet image forming apparatus of claim 22, wherein the guide slot comprises a parallel section to correspond to the third section of the cam groove to guide the platen to be disposed in the printing location, an inclined section to correspond to the second and third sections of the cam groove to guide the platen to move between the printing location and the maintenance location, and an extended section to correspond to the first section of the cam groove to guide the platen to be disposed in the maintenance location.

28. The ink-jet image forming apparatus of claim 20, wherein the platen comprises an interference portion to interfere a movement of the maintenance device to move according to a movement of the platen, and an opening formed on the interference portion, and the maintenance device comprises a portion controlled by the interference portion of the platen in the printing location and the maintenance location and released from the interference portion of the platen in the replacement location.

29. An ink-jet image forming apparatus comprising:
an ink-jet head including a nozzle unit to form an image having the same length as a width of a printing medium in a main scanning direction of the printing medium without moving in the main scanning direction;
a platen disposed to move between a printing location and a maintenance location;
a maintenance device detachably attached to the platen to maintain the nozzle unit according to a movement of the platen; and
a unit to move the maintenance device to a position in which the maintenance device is detachable from the platen in a replacement location.

30. The ink-jet image forming apparatus of claim 29, wherein the unit comprises a cam groove having a section to guide the maintenance device when the maintenance device is attached to the platen, and a replacement section formed on a portion of the section to release the maintenance device therefrom in the position.

31. The ink-jet image forming apparatus of claim 29, wherein the unit comprises a guide slot to guide the platen to move to the printing location, the maintenance location, and the replacement location corresponding to the position of the maintenance device.
